(19) United States
(12) Patent Application Publication
(10) Pub. No.: US 2026/0330597 A1
(43) Pub. Date: Oct. 22, 2026

(54) COMPLEMENTARY LEARNING METHOD AND APPARATUS FOR SUPER-RESOLUTION

(71) Applicant: UIF (University Industry Foundation), Yonsei University, Seoul (KR)

(72) Inventors: Won-Yong SHIN, Seoul (KR); Jiyeon KIM, Goyang-si (KR)

(21) Appl. No.: 19/651,540

(22) Filed: Apr. 17, 2026

(30) Foreign Application Priority Data
Apr. 21, 2025 (KR) 10-2025-0051329

(51) Int. Cl. G06T 3/4046; G06T 3/4053

(52) U.S. Cl. CPC G06T 3/4046; G06T 3/4053

(57) ABSTRACT

A complementary learning method for super-resolution includes: selecting two image pairs and one low-resolution image including low-resolution and high-resolution image pairs and a plurality of low-resolution images to obtain first to third low-resolution images and first and second ground-truth images; obtaining first to third image combinations composed of all distinct pairwise combinations of the first to third low-resolution images; performing neural network operations, by a super-resolution model and a super-resolution difference model, on the first to third low-resolution images and the first to third image combinations; estimating first to third predicted images and first to third difference prediction images; generating first and second pseudo-ground truths by combining the first and second ground-truth images with the second and third difference prediction images; generating first and second difference pseudo-ground truths by combining the first and second ground-truth images with the third predicted image; and calculating and backpropagating a super-resolution loss.

### CROSS-REFERENCE TO RELATED APPLICATIONS

This application claims priority under 35 U.S.C. § 119 (a) to Korean Patent Application No. 10-2025-0051329, filed on Apr. 21, 2025, with the Korean Intellectual Property Office, the disclosure of which is incorporated herein in its entirety by reference.

### TECHNICAL FIELD

The disclosed embodiments relate to a complementary learning method and apparatus, and more particularly, to a complementary learning method and apparatus that enables high super-resolution performance using a small number of high-resolution images.

### BACKGROUND ART

Recently, with the development of image technology, demand for high-resolution images has increased, and accordingly, interest has also grown in upscaling technology for converting low-resolution images into high-resolution images. Although various algorithms have been proposed as image upscaling technologies, it is known that a super-resolution technique, which is a method of performing operations using an artificial neural network, exhibits better performance than algorithms based on simple arithmetic operations.

However, in order for an artificial neural network-based super-resolution technique to have the required performance, sufficient training is required, and, for training, a large amount of training data composed of pairs of a low-resolution image and a corresponding high-resolution image is required. However, while it is easy to acquire a low-resolution image alone, it is not easy to acquire a large amount of training data in which low-resolution images and high-resolution images are paired.

### SUMMARY

### Technical Problem

An object of the disclosed embodiments is to provide a complementary learning method and apparatus capable of greatly improving super-resolution learning performance even in an environment in which pair data in which a low-resolution image and a high-resolution image form a pair is scarce.

Another object of the disclosed embodiments is to provide a complementary learning method and apparatus capable of generating pseudo-ground truths by utilizing, in training together with a super-resolution model, a super-resolution difference model for estimating a difference prediction image representing a difference between high-resolution images corresponding to low-resolution images.

### Solution to Problem

According to an embodiment, a complementary learning method includes: selecting two image pairs and one low-resolution image from training data including low-resolution and high-resolution image pairs and a plurality of low-resolution images to obtain first to third low-resolution images and first and second ground-truth images, and obtaining first to third image combinations composed of all distinct pairwise combinations of the first to third low-resolution images; performing neural network operations, by a super-resolution model and a super-resolution difference model, on the first to third low-resolution images and the first to third image combinations, thereby estimating first to third predicted images and first to third difference prediction images each estimating a difference between high-resolution resolution images of two low-resolution images included in a corresponding image combination; generating first and second pseudo-ground truths by combining the first and second ground-truth images with the second and third difference prediction images, and generating first and second difference pseudo-ground truths by combining the first and second ground-truth images with the third predicted image; and calculating and backpropagating a super-resolution loss calculated using the first and second ground-truth images and the first and second pseudo-ground truths and a difference loss calculated using (i) a first difference ground truth obtained from a difference between the first and second ground-truth images and (ii) the first and second difference pseudo-ground truths.

The generating of the pseudo-ground truths may generate the first pseudo-ground truth by subtracting the second difference prediction image from the second ground-truth image, and may generate the second pseudo-ground truth by adding the first ground-truth image to the third difference prediction image.

The generating of the pseudo-ground truths may generate the first difference pseudo-ground truth by subtracting the third predicted image from the second ground-truth image, and may generate the second difference pseudo-ground truth by subtracting the first ground-truth image from the third predicted image.

The backpropagating may calculate a super-resolution loss based on differences between the first to third estimated images and the first and second ground-truth images and the first and second pseudo-ground truths and backpropagate the super-resolution loss to the super-resolution model, and may calculate a difference loss based on differences between the first to third difference prediction images and the first difference ground truth and the first and second difference pseudo-ground truths and backpropagate the difference loss to the super-resolution difference model.

The super-resolution loss may be calculated as a cumulative sum of a difference between the first estimated image and the first ground-truth image, a difference between the second estimated image and the second ground-truth image, and differences between the third estimated image and each of the first and second pseudo-ground truths.

The difference loss may be calculated as a cumulative sum of a difference between the first difference prediction image and the first difference ground truth, a difference between the second difference prediction image and the first difference pseudo-ground truth, and a difference between the third difference prediction image and the second difference pseudo-ground truth.

The estimating may include the super-resolution model performing super-resolution on each of the first to third low-resolution images through neural network operations to obtain the first to third predicted images having high resolution, and the super-resolution difference model performing neural network operations on each of the first to third image combinations to obtain the first to third difference prediction images.

The super-resolution model and the super-resolution difference model may be pre-trained using the low-resolution and high-resolution image pairs.

The backpropagating may alternately calculate the super-resolution loss and the difference loss to alternately and repeatedly update the super-resolution model and the super-resolution difference model.

According to an embodiment, a complementary learning apparatus is an apparatus including a memory and a processor executing at least a part of operations according to a program stored in the memory, wherein the processor performs: selecting two image pairs and one low-resolution image from training data including low-resolution and high-resolution image pairs and a plurality of low-resolution images to obtain first to third low-resolution images and first and second ground-truth images, and obtaining first to third image combinations composed of all distinct pairwise combinations of the first to third low-resolution images; performing neural network operations, by a super-resolution model and a super-resolution difference model, on the first to third low-resolution images and the first to third image combinations, thereby estimating first to third predicted images and first to third difference prediction images each estimating a difference between high-resolution images of two low-resolution images included in a corresponding image combination; generating first and second pseudo-ground truths by combining the first and second ground-truth images with the second and third difference prediction images, and generating first and second difference pseudo-ground truths by combining the first and second ground-truth images with the third predicted image; and calculating and backpropagating a super-resolution loss calculated using the first and second ground-truth images and the first and second pseudo-ground truths and a difference loss calculated using (i) a first difference ground truth obtained from a difference between the first and second ground-truth images and (ii) the first and second difference pseudo-ground truths.

### Advantageous Effects of Invention

Accordingly, the complementary learning method and apparatus for super-resolution according to an embodiment can generate pseudo-ground truths by utilizing, in training together with a super-resolution model, a super-resolution difference model for estimating a difference prediction image having a difference between high-resolution images corresponding to low-resolution images, and thus can greatly improve super-resolution learning performance even in an environment in which pair data in which low-resolution images and high-resolution images form pairs is scarce.

### BRIEF DESCRIPTION OF DRAWINGS

FIG. 1 illustrates a configuration of a complementary learning apparatus for super-resolution divided according to operations according to an embodiment.

FIGS. 2 to 6 are diagrams for explaining the operation of the complementary learning apparatus of FIG. 1.

FIG. 7 illustrates a complementary learning method for super-resolution according to an embodiment.

FIG. 8 is a diagram for explaining a computing environment including a computing device according to an embodiment.

### DESCRIPTION OF EMBODIMENTS

Hereinafter, specific embodiments according to embodiments of the present disclosure will be described with reference to the drawings. The following detailed description is provided to aid comprehensive understanding of the methods, apparatuses, and/or systems described in the present specification. However, these are merely examples, and the present invention is not limited thereto.

In describing the embodiments of the present disclosure, when it is determined that a detailed description of related known technologies may unnecessarily obscure the gist of the embodiments, the detailed description thereof will be omitted. Further, terms to be described below are terms defined in consideration of functions in the present invention and may vary according to the intention or practice of users or operators. Accordingly, definitions thereof should be made based on the content throughout the present specification. Terms used in the detailed description are merely for describing certain embodiments and should never be limiting. Unless clearly used otherwise, expressions in the singular form include meanings in the plural form. In the present description, expressions such as “include” or “comprise” are intended to indicate certain features, numbers, steps, operations, elements, parts thereof, or combinations thereof, and should not be construed as excluding the existence or possibility of one or more other features, numbers, steps, operations, elements, parts thereof, or combinations thereof other than those described. In addition, terms such as “unit,” “device,” “module,” and “block” used in the specification mean a unit for processing at least one function or operation, and this may be implemented by hardware, software, or a combination of hardware and software.

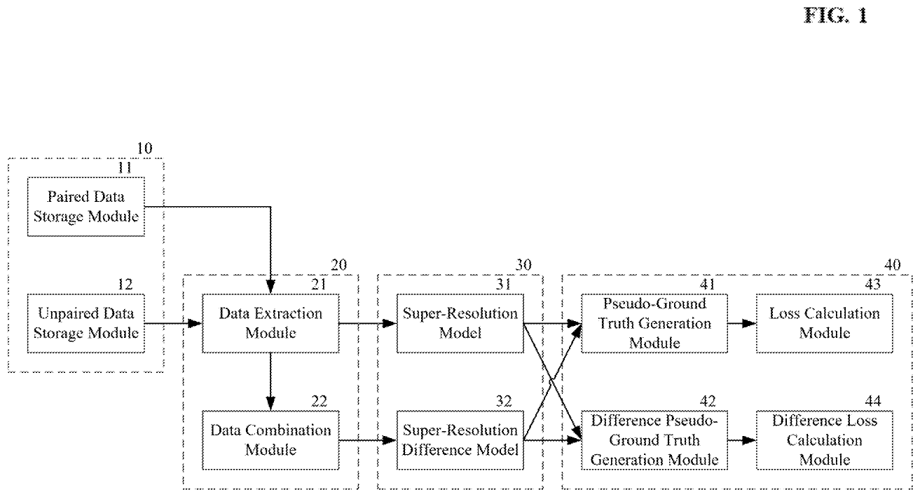

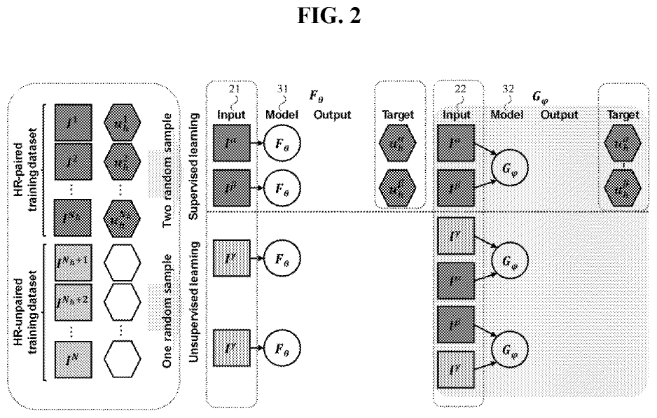

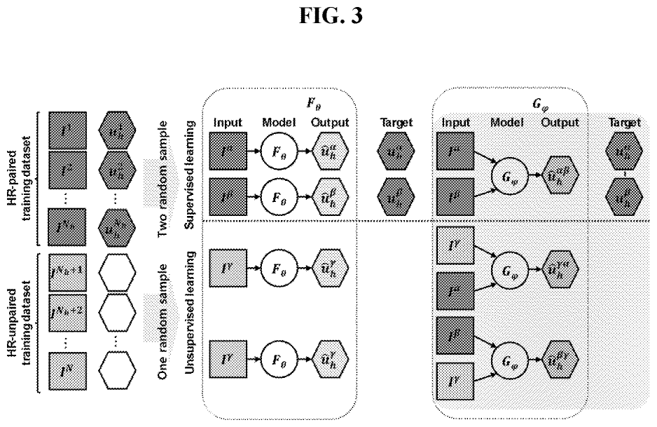

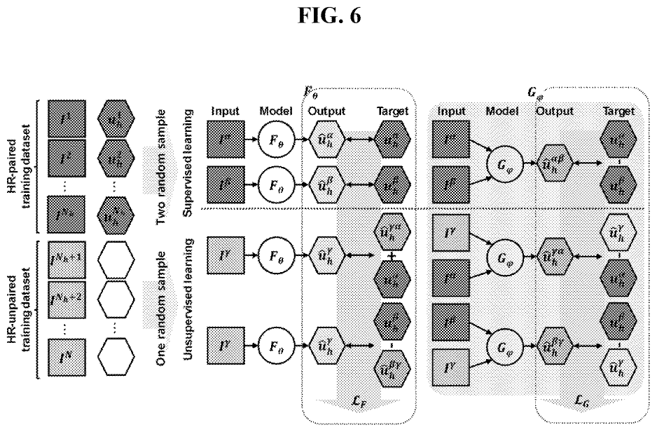

FIG. 1 illustrates a configuration of a complementary learning apparatus for super-resolution divided according to operations according to an embodiment, and FIGS. 2 to 6 are diagrams for explaining the operation of the complementary learning apparatus of FIG. 1.

Referring to FIG. 1, the complementary learning apparatus of an embodiment includes a learning data collection module 10, a learning data selection module 20, a super-resolution module 30, and a learning module 40.

The learning data collection module 10 stores learning data collected for super-resolution learning. The learning data collection module 10 may include a paired data storage module 11 and an unpaired data storage module 12. The paired data storage module 11 stores, as in the related art, paired data in which a low-resolution image and a high-resolution image form a pair. The unpaired data storage module 12 stores unpaired data composed only of low-resolution images for which there is no corresponding high-resolution image. As described above, while paired data in which a low-resolution image and a high-resolution image form a pair is difficult to collect, unpaired data composed only of low-resolution images is easy to collect, and thus the unpaired data storage module 12 may store more learning data than the paired data storage module 11.

The data selection module 20 selects and extracts data to be used for current learning from the unpaired data and paired data stored in the learning data collection module 10, and generates combined images by combining low-resolution data from the extracted data.

The data selection module 20 may include a data extraction module 21 and a data combination module 22. The data extraction module 21 extracts first and second paired data ((I^{α}, uₕ^{α}), (I^{β}, uₕ^{β})) from the paired data storage module 11 and extracts one unpaired sample (I^{γ}) from the unpaired data storage module 12. That is, it extracts two low-resolution/high-resolution image pairs ((I^{α}, uₕ^{α}), (I^{β}, uₕ^{β})) from the paired data storage module 11 and extracts one low-resolution image (I^{γ}) from the unpaired data storage module 12. Here, the low-resolution images of the first and second paired data ((I^{α}, uₕ^{α}), (I^{β}, uₕ^{β})) are referred to as a first low-resolution image I^{α} and a second low-resolution image I^{β}, respectively, and the high-resolution images are referred to as a first ground-truth image uₕ^{α} and a second ground-truth image uₕ^{β}, respectively. The unpaired sample is referred to as a third low-resolution image I^{γ}.

The data extraction module 21 transfers the extracted first to third low-resolution images (I^{α}, I^{β}, I^{γ}) to the data combination module 22 and, at the same time, to the super-resolution model 31 of the super-resolution module 30. The first and second ground-truth images (uₕ^{α}, uₕ^{β}) are transferred to the loss calculation module 43. The first and second ground-truth images (uₕ^{α}, uₕ^{β}) transferred to the loss calculation module 43 are used to calculate a super-resolution loss L_{F} for training the super-resolution model 31.

The data combination module 22 forms different combinations of two low-resolution images from the first to third low-resolution images (I^{α}, I^{β}, I^{γ}) transferred from the data extraction module 21.

The data combination module 22 may obtain a first image combination (I^{α}, I^{β}) by combining the first low-resolution image I^{α} and the second low-resolution image I^{β} obtained from the first and second paired data ((I^{α}, uₕ^{α}), (I^{β}, uₕ^{β})), obtain a second image combination (I^{β}, I^{γ}) by combining the second low-resolution image I^{β} and the third low-resolution image I^{γ}, and obtain a third image combination (I^{γ}, I^{α}) by combining the third low-resolution image I^{γ} and the first low-resolution image I^{α}. That is, the data combination module 22 may sequentially circulate through the first to third low-resolution images (I^{α}, I^{β}, I^{γ}) and select them in pairs to obtain first to third image combinations ((I^{α}, I^{β}), (I^{β}, I^{γ}), (I^{γ}, I^{α})).

The super-resolution module 30 performs neural network operations on the first to third low-resolution images (I^{α}, I^{β}, I^{γ}) and the first to third image combinations ((I^{α}, I^{β}), (I^{β}, I^{γ}), (I^{γ}, I^{α})) transferred from the data extraction module 21 and the data combination module 22, respectively, to obtain first to third predicted images

$$( {\hat{u}}_{h}^{α} {\hat{, u}}_{h}^{β} , {\hat{u}}_{h}^{γ} )$$

and first to third difference prediction images

$$( {\hat{u}}_{h}^{αβ} , {\hat{u}}_{h}^{βγ} , {\hat{u}}_{h}^{γα} ) .$$

The super-resolution module 30 may include a super-resolution model 31 and a super-resolution difference model 32. The super-resolution model 31 receives the first to third low-resolution images (I^{α}, I^{β}, I^{γ}) and performs neural network operations to obtain first to third predicted images

$$( {\hat{u}}_{h}^{α} , {\hat{u}}_{h}^{β} , {\hat{u}}_{h}^{γ} )$$

having high resolution.

The super-resolution difference model 32 receives the first to third image combinations ((I^{α}, I^{β}), (I^{β}, I^{γ}), (I^{γ}, I^{α})) and performs neural network operations to obtain first to third difference prediction images

$$( {\hat{u}}_{h}^{αβ} , {\hat{u}}_{h}^{βγ} , {\hat{u}}_{h}^{γα} )$$

representing differences between high-resolution images corresponding to the combined two low-resolution images.

When the first image combination (I^{α}, I^{β}) is input, the super-resolution difference model 32 obtains a first difference prediction image

$$( {\tilde{u}}_{h}^{α} - {\tilde{u}}_{h}^{β} = {\tilde{u}}_{h}^{αβ} )$$

obtained by subtracting an estimated high-resolution image

$$( {\tilde{u}}_{h}^{β} )$$

for the second low-resolution image I^{β} from an estimated high-resolution image

$$( {\tilde{u}}_{h}^{α} )$$

for the first low-resolution image I^{α}. When the second image combination (I^{β}, I^{γ}) is input, it obtains a second difference prediction image

$$( {\tilde{u}}_{h}^{β} - {\tilde{u}}_{h}^{γ} = {\hat{u}}_{h}^{βγ} )$$

obtained by subtracting an estimated high-resolution image

$$( {\tilde{u}}_{h}^{γ} )$$

for the third low-resolution image I^{γ} from an estimated high-resolution image

$$( {\tilde{u}}_{h}^{β} )$$

for the second low-resolution image I^{β}, and when the third image combination (I^{γ}, I^{α}) is input, it obtains a third difference prediction image

$$( {\tilde{u}}_{h}^{γ} - {\tilde{u}}_{h}^{α} = {\hat{u}}_{h}^{γ α} )$$

obtained by subtracting an estimated high-resolution image

$$( {\tilde{u}}_{h}^{α} )$$

for the first low-resolution image I^{α} from an estimated high-resolution resolution image

$$( {\tilde{u}}_{h}^{γ} )$$

for the third low-resolution image I^{γ}.

Here, since the super-resolution model 31 and the super-resolution difference model 32 are different neural network models, the first to third predicted images

$$( {\hat{u}}_{h}^{α} , {\hat{u}}_{h}^{β} , {\hat{u}}_{h}^{γ} )$$

and the first to third estimated images

$$( {\tilde{u}}_{h}^{α} , {\tilde{u}}_{h}^{β} , {\tilde{u}}_{h}^{γ} )$$

are all high-resolution images but differ from each other. When each of the first to third image combinations ((I^{α}, I^{β}), (I^{β}, I^{γ}), (I^{γ}, I^{α})) is used as input, it obtains two estimated high-resolution images

$$( ( {\tilde{u}}_{h}^{α} , {\tilde{u}}_{h}^{β} ) , ( {\tilde{u}}_{h}^{β} , {\tilde{u}}_{h}^{γ} ) , ( {\tilde{u}}_{h}^{γ} , {\tilde{u}}_{h}^{α} ) )$$

for the input low-resolution image combinations, and then subtracts them to obtain the difference prediction images

$$( {\hat{u}}_{h}^{αβ} , {\hat{u}}_{h}^{βγ} , {\hat{u}}_{h}^{γα} ) .$$

However, this is a description for understanding purposes, and the super-resolution difference model 32 may be trained such that when each of the image combinations ((I^{α}, I^{β}), (I^{β}, I^{γ}), (I^{γ}, I^{α})) is input, it directly obtains the difference prediction images

$$( {\hat{u}}_{h}^{αβ} , {\hat{u}}_{h}^{βγ} , {\hat{u}}_{h}^{γα} )$$

without obtaining the estimated images

$$( ( {\tilde{u}}_{h}^{α} , {\tilde{u}}_{h}^{β} ) , ( {\tilde{u}}_{h}^{β} , {\tilde{u}}_{h}^{γ} ) , ( {\tilde{u}}_{h}^{γ} , {\tilde{u}}_{h}^{α} ) ) .$$

Therefore, the estimated images

$$( {\tilde{u}}_{h}^{α} , {\tilde{u}}_{h}^{β} , {\tilde{u}}_{h}^{γ} )$$

may not be actually obtained images, but rather images used to explain the difference prediction images

$$( {\hat{u}}_{h}^{αβ} , {\hat{u}}_{h}^{βγ} , {\hat{u}}_{h}^{γα} ) .$$

In the super-resolution module 30, the super-resolution model 31 is trained in the complementary learning manner according to an embodiment and is a neural network model that actually estimates a high-resolution image by receiving a low-resolution image as input, and may be regarded as a super-resolution apparatus to be trained. The super-resolution difference model 32 is a neural network model added to improve the learning performance of the super-resolution model 31 in an environment in which paired data is insufficient and is trained while complementing the super-resolution model 31. The super-resolution difference model 32 may be removed after training of the super-resolution model 31 is completed.

The learning module 40 performs learning for the super-resolution model 31 and the super-resolution difference model 32 of the super-resolution module 30. In one embodiment, the learning module 40 generates virtual pseudo-ground truths together with the first and second high-resolution ground-truth images (uₕ^{α} and uₕ^{β}) included in paired data and performs complementary learning, such that the super-resolution model 31 and the super-resolution difference model 32 are effectively trained even in a training environment in which paired data is insufficient.

The learning module 40 may include a pseudo-ground truth generation module 41, a difference pseudo-ground truth generation module 42, a loss calculation module 43, and a difference loss calculation module 44.

The pseudo-ground truth generation module 41 and the difference pseudo-ground and difference truth generation module 42 generate virtual pseudo-ground truths

$$( {\tilde{u}}_{h}^{γ 1} , {\tilde{u}}_{h}^{γ 2} )$$

and difference pseudo-ground truths

$$( {\tilde{u}}_{h}^{βγ} , {\tilde{u}}_{h}^{γα} ) ,$$

respectively, and the loss calculation module 43 and the difference loss calculation module 44 calculate losses (L_{F}, L_{G}) for training the super-resolution model 31 and the super-resolution difference model 32, respectively, and backpropagate the obtained losses (L_{F}, L_{G}) to the super-resolution model 31 and the super-resolution difference model 32, respectively.

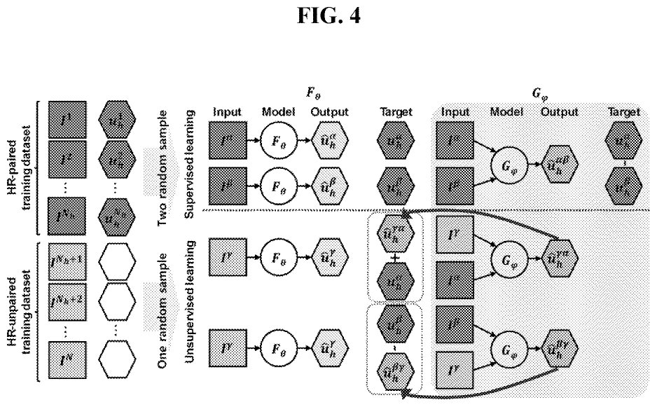

First, as illustrated in FIG. 4, the pseudo-ground truth generation module 41 receives the first and second ground-truth images (uₕ^{α}, uₕ^{β}) obtained by the data extraction module 21 and the second and third difference prediction images

$$( {\hat{u}}_{h}^{βγ} , {\hat{u}}_{h}^{γα} )$$

among the first to third difference prediction images

$$( {\hat{u}}_{h}^{αβ} , {\hat{u}}_{h}^{βγ} , {\hat{u}}_{h}^{γα} )$$

obtained by the super-resolution difference model 32, and combines them to generate two pseudo-ground truths

$$( {\tilde{u}}_{h}^{γ1} , {\tilde{u}}_{h}^{γ 2} )$$

for the third low-resolution image I^{γ}.

Specifically, the pseudo-ground truth generation module 41 receives the second and third difference prediction images

$$( {\hat{u}}_{h}^{βγ} , {\hat{u}}_{h}^{γα} )$$

estimated from two combined images I^{βγ} and I^{γα} including unpaired data, that is, the third low-resolution image I^{γ} for which there is no corresponding high-resolution image, and the two ground-truth images (uₕ^{α}, uₕ^{β}) of the paired data. It then generates a first pseudo-ground truth

$$( {\tilde{u}}_{h}^{γ1} )$$

for the third low-resolution image I^{γ} by subtracting the second difference prediction image

$$( {\hat{u}}_{h}^{βγ} )$$

from the second ground-truth image

$${u}_{h}^{β} ( {u}_{h}^{β} - {\hat{u}}_{h}^{βγ} ) ,$$

and obtains a second pseudo-ground truth

$$( {\tilde{u}}_{h}^{γ 2} )$$

for the third low-resolution image I^{γ} by adding the first ground-truth image uₕ^{α} to the third difference prediction image

$$( {\hat{u}}_{h}^{γα} + {u}_{h}^{α} ) .$$

As described above, since the second difference prediction image

$$( {\hat{u}}_{h}^{βγ} )$$

is an image obtained by subtracting

$$( {\tilde{u}}_{h}^{β} - {\tilde{u}}_{h}^{γ} )$$

an estimated high-resolution image

$$( {\tilde{u}}_{h}^{γ} )$$

for the third low-resolution image I^{γ} from an estimated high-resolution image

$$( {\tilde{u}}_{h}^{β} )$$

for the second low-resolution image I^{β}, if the super-resolution model 31 and the super-resolution difference model 32 are sufficiently trained, the first pseudo-ground truth

$$( {\tilde{u}}_{h}^{γ1} )$$

obtained by subtracting the second difference prediction image

$$( {\hat{u}}_{h}^{βγ} )$$

from the second pseudo-ground truth image

$${u}_{h}^{β} ( {u}_{h}^{β} - {\hat{u}}_{h}^{β γ} = {u}_{h}^{β} - ( {\tilde{u}}_{h}^{β} - {\tilde{u}}_{h}^{γ} ) )$$

should be similar

$$( {\tilde{u}}_{h}^{{γ}^{1}} \approx {\hat{u}}_{h}^{γ} )$$

to the third predicted image

$$( {\hat{u}}_{h}^{γ} ) .$$

Likewise, since the third difference prediction image

$$( {\hat{u}}_{h}^{γ α} )$$

is an image obtained by subtracting

$$( {\tilde{u}}_{{h}_{-}}^{γ} {\tilde{u}}_{h}^{α} )$$

an estimated high-resolution image

$$( {\tilde{u}}_{h}^{α} )$$

for the first low-resolution image I^{α} from an estimated high-resolution image

$$( {\tilde{u}}_{h}^{γ} )$$

for the third low-resolution I^{γ}, the second pseudo-ground truth

$$( {\tilde{u}}_{h}^{{γ}^{2}} )$$

obtained by adding the first ground-truth image uₕ^{α} to the third difference prediction image

$$( {\hat{u}}_{h}^{βγ} ) ( {\hat{u}}_{h}^{γα} + {u}_{h}^{α} = ( {\tilde{u}}_{h}^{γ} - {\tilde{u}}_{h}^{α} ) + {u}_{h}^{α} )$$

should also be similar

$$( {\tilde{u}}_{h}^{{γ}^{2}} \approx {\hat{u}}_{h}^{γ} )$$

to the third prediction image

$$( {\hat{u}}_{h}^{γ} ) .$$

Accordingly, when the super-resolution difference model 32 is in a sufficiently trained state, the first and second pseudo-ground truths

$$( {\tilde{u}}_{h}^{{γ}^{1}} , {\tilde{u}}_{h}^{{γ}^{2}} )$$

may be used as virtual ground truths for training the super-resolution model 31 with the third low-resolution image I^{γ}.

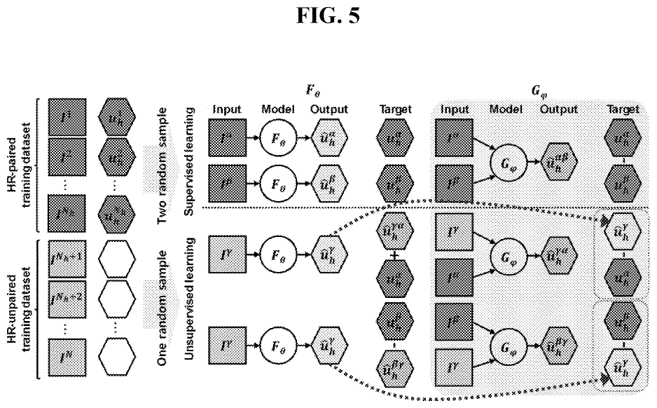

Meanwhile, as illustrated in FIG. 5, the difference pseudo-ground truth generation module 42 receives the first and second ground-truth images (uₕ^{α}, uₕ^{β}) obtained by the data extraction module 21 and the third predicted image

$$( {\hat{u}}_{h}^{γ} )$$

obtained by the super-resolution model 31, and combines them to generate two difference pseudo-ground truths

$$( {\tilde{u}}_{h}^{βγ} , {\tilde{u}}_{h}^{γα} )$$

respectively corresponding to the second and third difference prediction images

$$( {\hat{u}}_{h}^{βγ} , {\hat{u}}_{h}^{γα} ) .$$

The difference pseudo-ground truth generation module 42 generates a first difference pseudo-ground truth

$$( {\tilde{u}}_{h}^{βγ} )$$

corresponding to the second difference prediction image

$$( {\hat{u}}_{h}^{βγ} )$$

by subtracting the third predicted image

$$( {\hat{u}}_{h}^{γ} )$$

from the second ground-truth image

$${u}_{h}^{β} ( {u}_{h}^{β} - {\hat{u}}_{h}^{γ} ) .$$

It then generates a second difference pseudo-ground truth

$$( {\tilde{u}}_{h}^{γα} )$$

corresponding to the third difference prediction image

$$( {\tilde{u}}_{h}^{γα} )$$

by subtracting the first ground-truth image uₕ^{α} from the third prediction image

$$( {\hat{u}}_{h}^{γ} - {u}_{h}^{α} ) .$$

When the super-resolution model 31 is in a sufficiently third predicted image trained state, the first and second difference pseudo-ground truths

$$( {\tilde{u}}_{h}^{βγ} , {\tilde{u}}_{h}^{γα} )$$

may be used as virtual ground truths for training the super-resolution difference model 32 with the third low-resolution image I^{γ}.

The difference pseudo-ground truth generation module 42 may also be referred to as a difference pseudo-ground truth generation module.

However, in order for not only the super-resolution model 31 but also the super-resolution difference model 32 to be independently trained, a large amount of paired data is required. Accordingly, here, by together utilizing a large amount of unpaired data in an environment in which paired data is insufficient and by alternately or simultaneously training the super-resolution model 31 and the super-resolution difference model 32, the super-resolution model 31 and the super-resolution difference model 32 are trained complementarily together in a training environment in which paired data is insufficient.

The loss calculation module 43 receives the first to third predicted images

$$( {\hat{u}}_{h}^{α} , {\hat{u}}_{h}^{β} , {\hat{u}}_{h}^{γ} )$$

obtained by the super-resolution model 31, the first and second ground-truth images (uₕ^{α}, uₕ^{β}) obtained by the data extraction module 21, and the first and second pseudo-ground truths

$$( {\tilde{u}}_{h}^{γ 1} , {\tilde{u}}_{h}^{γ 2} )$$

generated by the pseudo-ground truth generation module 41, calculates a super-resolution loss L_{F} according to Equation 1, and backpropagates the calculated super-resolution loss L_{F} to the super-resolution model 31.

$${ℒ}_{F} = ℓ ( {\hat{u}}_{h}^{α β} , {u}_{h}^{β} ) + ℓ ( {\hat{u}}_{h}^{β} , {u}_{h}^{β} ) + ℓ ( {\hat{u}}_{h}^{γ} , {\tilde{u}}_{h}^{γ 1} ) + ℓ ( {\hat{u}}_{h}^{γ} , {\tilde{u}}_{h}^{γ 2} ) \qquad [ Equation 1 ]$$

Here, l(⋅, ⋅) is a function for calculating MSE (Mean Squared Error).

Meanwhile, the difference loss calculation module 44 receives the first to third difference prediction images

$$( {\hat{u}}_{h}^{αβ} , {\hat{u}}_{h}^{βγ} , {\hat{u}}_{h}^{γα} )$$

obtained by the super-resolution difference model 32. It also receives the first and second ground-truth images (uₕ^{α}, uₕ^{β}) and obtains a first difference ground truth

$$( {u}_{h}^{αβ} )$$

by subtracting the second ground-truth image uₕ^{β} from the first ground-truth image uₕ^{α} (uₕ^{α}−uₕ^{β}), and also receives the first and second difference pseudo-ground truths

$$( {\tilde{u}}_{h}^{βγ} , {\tilde{u}}_{h}^{γα} )$$

generated by the difference pseudo-ground truth generation module 42.

It then calculates a difference loss L_{G} according to Equation 2 based on the first to third difference prediction images

$$( {\hat{u}}_{h}^{αβ} , {\hat{u}}_{h}^{βγ} , {\hat{u}}_{h}^{γα} ) ,$$

the first difference ground truth

$$( {u}_{h}^{αβ} ) ,$$

and the first and second difference pseudo-ground truths

$$( {\tilde{u}}_{h}^{βγ} , {\tilde{u}}_{h}^{γα} ) ,$$

and backpropagates the calculated difference loss (L_{G}) to the super-resolution difference model 32.

$${ℒ}_{G} = ℓ ( {\hat{u}}_{h}^{α β} , {u}_{h}^{αβ} ) + ℓ ( {\hat{u}}_{h}^{β γ} , {\tilde{u}}_{h}^{β γ} ) + ℓ ( {\hat{u}}_{h}^{γα} , {\tilde{u}}_{h}^{γα} ) \qquad [ Equation 2 ]$$

Here again, l(⋅, ⋅) is a function for calculating MSE (Mean Squared Error).

That is, the loss calculation module 43 and the difference loss calculation module 44 individually train the super-resolution model 31 and the super-resolution difference model 32, respectively.

For example, first, the loss calculation module 43 calculates a super-resolution loss L_{F} using the first and second pseudo-ground truths

$$( {\tilde{u}}_{h}^{γ 1} , {\tilde{u}}_{h}^{γ 2} )$$

estimated by the super-resolution difference model 32 based on the second and third difference prediction images

$$( {\hat{u}}_{h}^{βγ} , {\hat{u}}_{h}^{γα} )$$

and the first and second ground-truth images (uₕ^{α}, uₕ^{β}), and backpropagates the super-resolution loss L_{F} to train and update the super-resolution model 31.

The difference loss calculation module 44 then calculates the difference loss L_{G} using the first difference ground truth

$$( {u}_{h}^{αβ} )$$

obtained from the first and second ground-truth images (uₕ^{α}, uₕ^{β}) together with the third predicted image

$$( {\hat{u}}_{h}^{γ} )$$

and the first and second difference pseudo-ground truths

$$( {\tilde{u}}_{h}^{βγ} , {\tilde{u}}_{h}^{γα} )$$

obtained based on the third predicted image, and backpropagates the difference loss L_{G} to train and update the super-resolution difference model 32.

The learning module 40 may cause the super-resolution model 31 and the super-resolution difference model 32 to be trained complementarily together by repeatedly performing the above-described process.

In the above, it has only been described that the learning module 40 performs learning by generating the first and second pseudo-ground truths

$$( {\tilde{u}}_{h}^{γ1} , {\tilde{u}}_{h}^{γ2} )$$

and the first and second difference pseudo-ground truths

$$( {\tilde{u}}_{h}^{βγ} , {\tilde{u}}_{h}^{γα} )$$

once. However, the learning module 40 may repeatedly perform the above-described process so that the first and second pseudo-ground truths

$$( {\tilde{u}}_{h}^{γ1} , {\tilde{u}}_{h}^{γ2} )$$

and the first and second difference pseudo-ground truths

$$( {\tilde{u}}_{h}^{βγ} , {\tilde{u}}_{h}^{γα} )$$

may be generated with updated data so that unpaired data may also be utilized for complementary learning of the super-resolution model 31 and the super-resolution difference model 32.

As a result, in an environment in which the super-resolution model 31 cannot be normally trained because paired data in which a low-resolution image and a high-resolution image form a pair is insufficient, the complementary learning apparatus for super-resolution according to an embodiment may train the super-resolution model 31 and the super-resolution difference model 32 together through complementary learning by together utilizing a large amount of unpaired data including only low-resolution images, such that the super-resolution model 31 may be trained to have excellent super-resolution performance.

In the illustrated embodiment, each component may have functions and capabilities different from those described above and may include additional components not described. In addition, in one embodiment, each component may be implemented using one or more physically separate devices, or may be implemented by one or more processors or by a combination of one or more processors and software, and may not be clearly distinguished in specific operations unlike the illustrated example.

In addition, the complementary learning apparatus for super-resolution illustrated in FIG. 1 may be implemented within a logic circuit by hardware, firmware, software, or a combination thereof, and may also be implemented using a general-purpose or special-purpose computer. The apparatus may be implemented using a hardwired device, a field programmable gate array (FPGA), an application specific integrated circuit (ASIC), or the like. The apparatus may also be implemented as a system on chip (SoC) including one or more processors and controllers.

Further, the super-resolution learning apparatus may be mounted in the form of software, hardware, or a combination thereof on a computing device or server provided with hardware elements. The computing device or server may mean various devices including, in whole or in part, a communication device such as a communication modem for performing communication with various devices or wired/wireless communication networks, a memory for storing data for executing a program, and a microprocessor for executing a program to perform operations and commands.

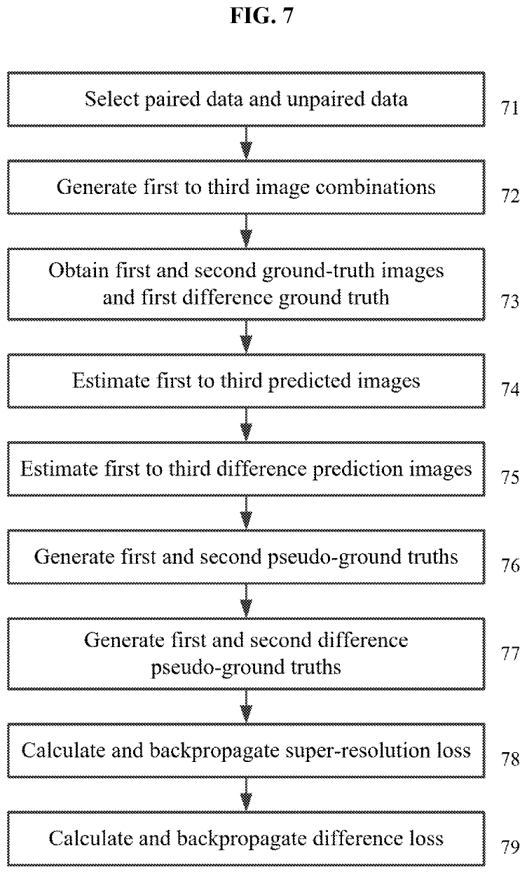

FIG. 7 illustrates a complementary learning method for super-resolution according to an embodiment.

Among training data including paired data composed of low-resolution images and high-resolution images in pairs and a large amount of unpaired data composed only of low-resolution images, two paired samples and one unpaired sample are selected in step S71. Then, three low-resolution images (I^{α}, I^{β}, I^{γ}) of the selected two paired samples and one unpaired sample are configured into different pairwise combinations to generate first to third image combinations ((I^{α}, I^{β}), (I^{β}, I^{γ}), (I^{γ}, I^{α})) in step S72.

Here, the high-resolution images of the selected two paired data are obtained as first and second ground-truth images (uₕ^{α}, uₕ^{β}), respectively, and the difference (uₕ^{α}−uₕ^{β}) between the first and second ground-truth images (uₕ^{α}, uₕ^{β}) may be obtained as a first difference ground truth

$$( {u}_{h}^{αβ} )$$

in step S73.

Meanwhile, the three low-resolution images (I^{α}, I^{β}, I^{γ}) are each super-resolved by the super-resolution model 31 through neural network operations to estimate first to third predicted images

$$( {\hat{u}}_{h}^{α} , {\hat{u}}_{h}^{β} , {\hat{u}}_{h}^{γ} )$$

having high resolution in step S74. In addition, the first to third image combinations ((I^{α}, I^{β}), (I^{β}, I^{γ}), (I^{γ}, I^{α})) are each processed by the super-resolution difference model 32 through neural network operations to obtain first to third difference prediction images

$$( {\hat{u}}_{h}^{αβ} , {\hat{u}}_{h}^{βγ} , {\hat{u}}_{h}^{γα} )$$

representing differences between high-resolution images of the corresponding combined two low-resolution images in step S75.

When the first to third predicted images

$$( {\hat{u}}_{h}^{α} , {\hat{u}}_{h}^{β} , {\hat{u}}_{h}^{γ} )$$

and the first to third difference prediction images

$$( {\hat{u}}_{h}^{αβ} , {\hat{u}}_{h}^{βγ} , {\hat{u}}_{h}^{γα} )$$

are estimated, the first and second ground-truth images (uₕ^{α}, uₕ^{β}) and the second and third difference prediction images

$$( {\hat{u}}_{h}^{βγ} , {\hat{u}}_{h}^{γα} )$$

are combined to generate first and second pseudo-ground truths

$$( {\tilde{u}}_{h}^{γ1} , {\tilde{u}}_{h}^{γ2} )$$

in step S76. Specifically, a first pseudo-ground truth

$$( {\tilde{u}}_{h}^{γ1} )$$

is generated by subtracting the second difference prediction image

$$( {\tilde{u}}_{h}^{βγ} )$$

from the second ground-truth image uₕ^{β}, and a second pseudo-ground truth

$$( {\tilde{u}}_{h}^{γ2} )$$

is generated by adding the first ground-truth image uₕ^{α} to the third difference prediction image

$$( {\hat{u}}_{h}^{γα} + {u}_{h}^{α} )$$

The first and second ground-truth images (uₕ^{α}, uₕ^{β}) and the third predicted image

$$( {\hat{u}}_{h}^{γ} )$$

are combined to generate first and second difference pseudo-ground truths

$$( {\tilde{u}}_{h}^{βγ} , {\tilde{u}}_{h}^{γα} )$$

in step S77. Here, the first difference pseudo-ground truth

$$( {\tilde{u}}_{h}^{βγ} )$$

may be generated by subtracting the third predicted image

$$( {\hat{u}}_{h}^{γ} )$$

from the second ground-truth image uₕ^{β}, and the second difference pseudo-ground truth

$$( {\tilde{u}}_{h}^{γα} )$$

may be generated by subtracting the first ground-truth image uₕ^{α} from the third predicted image

$$( {\hat{u}}_{h - {u}_{h}^{α}}^{γ} )$$

When the first and second ground-truth images (uₕ^{α}, uₕ^{β}) and the first difference ground truth

$$( {u}_{h}^{αβ} )$$

are obtained, and the first and second pseudo-ground truths

$$( {\tilde{u}}_{h}^{γ 1} , {\tilde{u}}_{h}^{γ 2} )$$

and the first and second difference pseudo-ground truths

$$( {\tilde{u}}_{h}^{βγ} , {\tilde{u}}_{h}^{γα} )$$

are generated, a super-resolution loss L_{F} is calculated according to differences (here, MSE) between the first to third predicted images

$$( {\hat{u}}_{h}^{α} , {\hat{u}}_{h}^{β} , {\hat{u}}_{h}^{γ} )$$

and the first and second ground-truth images (uₕ^{α}, uₕ^{β}) and the first and second pseudo-ground truths

$$( {\tilde{u}}_{h}^{γ 1} , {\tilde{u}}_{h}^{γ 2} ) ,$$

and the calculated super-resolution loss L_{F} is backpropagated to train the super-resolution model 31 in step S78.

A difference loss L_{G} is then calculated according to differences (here, MSE) between the first to third difference prediction images

$$( {\hat{u}}_{h}^{αβ} , {\hat{u}}_{h}^{βγ} , {\hat{u}}_{h}^{γα} ) ,$$

the first difference ground truth

$$( {u}_{h}^{αβ} ) ,$$

and the first and second difference pseudo-ground truths

$$( {\tilde{u}}_{h}^{βγ} , {\tilde{u}}_{h}^{γα} ) ,$$

and the calculated difference loss L_{G} is backpropagated to train the super-resolution difference model 32 in step S79.

Although it has been described herein that both the super-resolution loss L_{F} and the difference loss L_{G} are calculated to train the super-resolution model 31 and the super-resolution difference model 32 simultaneously, alternatively, the super-resolution loss L_{F} may be first calculated to train the super-resolution model 31, and then upon re-performing from the step of estimating the first to third predicted images

$$( {\hat{u}}_{h}^{α} , {\hat{u}}_{h}^{β} , {\hat{u}}_{h}^{γ} ) ,$$

the difference loss L_{G} may be calculated to alternately update the super-resolution difference model 32 and the super-resolution model 31 until the super-resolution loss L_{F} and the difference loss L_{G} both become equal to or less than a reference loss.

In FIG. 7, each process is described as being sequentially executed, but this is merely an illustrative description, and those skilled in the art may variously modify and apply the present invention by changing the order described in FIG. 7, executing one or more processes in parallel, or adding other processes, without departing from the essential characteristics of the embodiments of the present invention.

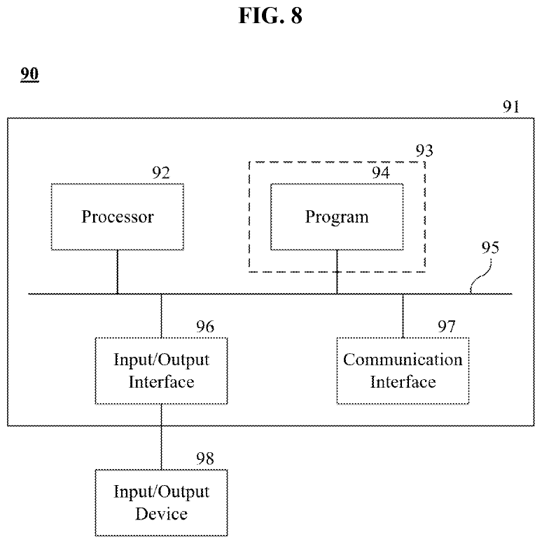

FIG. 8 is a diagram for explaining a computing environment including a computing device according to an embodiment.

In the illustrated embodiment, each component may have functions and capabilities different from those described below and may further include components in addition to those described below. The illustrated computing environment 90 includes a computing device 91 and may perform the complementary learning method for super-resolution illustrated in FIG. 7. In one embodiment, the computing device 91 may be one or more components included in the complementary learning apparatus for super-resolution illustrated in FIG. 1.

The computing device 91 includes at least one processor 92, a computer-readable storage medium 93, and a communication bus 95. The processor 92 may cause the computing device 91 to operate according to the exemplary embodiments described above. For example, the processor 92 may execute one or more programs 94 stored in the computer-readable storage medium 93. The one or more programs 94 may include one or more computer-executable instructions, and the computer-executable instructions may be configured to cause the computing device 91 to perform operations according to the exemplary embodiments when executed by the processor 92.

The communication bus 95 interconnects the processor 92, the computer-readable storage medium 93, and various other components of the computing device 91.

The computing device 91 may also include one or more input/output interfaces 96 providing interfaces for one or more input/output devices 98, and one or more communication interfaces 97. The input/output interfaces 96 and the communication interfaces 97 are connected to the communication bus 95. The input/output devices 98 may be connected to other components of the computing device 91 through the input/output interfaces 96. Exemplary input/output devices 98 may include input devices such as a pointing device (e.g., a mouse or trackpad), a keyboard, a touch input device (e.g., a touchpad or touchscreen), a voice or sound input device, various kinds of sensor devices, and/or an imaging device, and/or output devices such as a display device, a printer, a speaker, and/or a network card. The exemplary input/output devices 98 may be included inside the computing device 91 as one component constituting the computing device 91, or may be connected to the computing device 91 as separate devices distinct from the computing device 91.

While representative embodiments have been described above in detail with respect to the present invention, those skilled in the art will understand that various modifications and equivalent other embodiments are possible therefrom. Accordingly, the true technical protection scope of the present invention should be determined by the technical spirit of the appended claims.

What is claimed is:

1. A complementary learning method comprising:
selecting two image pairs and one low-resolution image from training data including low-resolution and high-resolution image pairs and a plurality of low-resolution images to obtain first to third low-resolution images and first and second ground-truth images, and obtaining first to third image combinations composed of all distinct pairwise combinations of the first to third low-resolution images;
performing neural network operations, by a super-resolution model and a super-resolution difference model, on the first to third low-resolution images and the first to third image combinations, thereby estimating first to third predicted images and first to third difference prediction images each estimating a difference between high-resolution images of two low-resolution images included in a corresponding image combination;
generating first and second pseudo-ground truths by combining the first and second ground-truth images with the second and third difference prediction images, and generating first and second difference pseudo-ground truths by combining the first and second ground-truth images with the third predicted image; and
calculating and backpropagating a super-resolution loss calculated using the first and second ground-truth images and the first and second pseudo-ground truths and a difference loss calculated using (i) a first difference ground truth obtained from a difference between the first and second ground-truth images and (ii) the first and second difference pseudo-ground truths.

2. The complementary learning method of claim 1, wherein the generating of the first and second pseudo-ground truths includes generating the first pseudo-ground truth by subtracting the second difference prediction image from the second ground-truth image, and generating the second pseudo-ground truth by adding the first ground-truth image to the third difference prediction image.

3. The complementary learning method of claim 1, wherein the generating of the first and second pseudo-ground truths includes generating the first difference pseudo-ground truth by subtracting the third predicted image from the second ground-truth image, and generating the second difference pseudo-ground truth by subtracting the first ground-truth image from the third predicted image.

4. The complementary learning method of claim 1, wherein the backpropagating includes calculating a super-resolution loss based on differences between the first to third estimated predicted images and the first and second ground-truth images and the first and second pseudo-ground truths and backpropagating the super-resolution loss to the super-resolution model, and calculating a difference loss based on differences between the first to third difference prediction images and the first difference ground truth and the first and second difference pseudo-ground truths and backpropagating the difference loss to the super-resolution difference model.

5. The complementary learning method of claim 4, wherein the super-resolution loss is calculated as a cumulative sum of a difference between the first estimated predicted image and the first ground-truth image, a difference between the second estimated predicted image and the second ground-truth image, and differences between the third estimated predicted image and each of the first and second pseudo-ground truths.

6. The complementary learning method of claim 4, wherein the difference loss is calculated as a cumulative sum of a difference between the first difference prediction image and the first difference ground truth, a difference between the second difference prediction image and the first difference pseudo-ground truth, and a difference between the third difference prediction image and the second difference pseudo-ground truth.

7. The complementary learning method of claim 1, wherein the estimating includes the super-resolution model performing super-resolution on each of the first to third low-resolution images through neural network operations to obtain the first to third predicted images having high resolution, and the super-resolution difference model performing neural network operations on each of the first to third image combinations to obtain the first to third difference prediction images.

8. The complementary learning method of claim 1, wherein the super-resolution model and the super-resolution difference model are pre-trained using the low-resolution and high-resolution image pairs.

9. The complementary learning method of claim 1, wherein the backpropagating includes alternately calculating the super-resolution loss and the difference loss to alternately and repeatedly update the super-resolution model and the super-resolution difference model.

10. The complementary learning method of claim 1, wherein the complementary learning method is performed by a processor of an apparatus including a memory and the processor.

11. A complementary learning apparatus comprising: a memory; and a processor executing at least a part of operations according to a program stored in the memory, wherein the processor performs:
selecting two image pairs and one low-resolution image from training data including low-resolution and high-resolution image pairs and a plurality of low-resolution images to obtain first to third low-resolution images and first and second ground-truth images, and obtaining first to third image combinations composed of all distinct pairwise combinations of the first to third low-resolution images;
performing neural network operations, by a super-resolution model and a super-resolution difference model, on the first to third low-resolution images and the first to third image combinations, thereby estimating first to third predicted images and first to third difference prediction images each estimating a difference between high-resolution images of two low-resolution images included in a corresponding image combination;
generating first and second pseudo-ground truths by combining the first and second ground-truth images with the second and third difference prediction images, and generating first and second difference pseudo-ground truths by combining the first and second ground-truth images with the third predicted image; and
calculating and backpropagating a super-resolution loss calculated using the first and second ground-truth images and the first and second pseudo-ground truths and a difference loss calculated using (i) a first difference ground truth obtained from a difference between the first and second ground-truth images and (ii) the first and second difference pseudo-ground truths.

12. The complementary learning apparatus of claim 11, wherein the generating of the pseudo-ground truths includes generating the first pseudo-ground truth by subtracting the second difference prediction image from the second ground-truth image, and generating the second pseudo-ground truth by adding the first ground-truth image to the third difference prediction image.

13. The complementary learning apparatus of claim 11, wherein the generating of the pseudo-ground truths includes generating the first difference pseudo-ground truth by subtracting the third predicted image from the second ground-truth image, and generating the second difference pseudo-ground truth by subtracting the first ground-truth image from the third predicted image.

14. The complementary learning apparatus of claim 11, wherein the backpropagating includes calculating a super-resolution loss based on differences between the first to third estimated predicted images and the first and second ground-truth images and the first and second pseudo-ground truths and backpropagating the super-resolution loss to the super-resolution model, and calculating a difference loss based on differences between the first to third difference prediction images and the first difference ground truth and the first and second difference pseudo-ground truths and backpropagating the difference loss to the super-resolution difference model.

15. The complementary learning apparatus of claim 14, wherein the super-resolution loss is calculated as a cumulative sum of a difference between the first estimated predicted image and the first ground-truth image, a difference between the second estimated predicted image and the second ground-truth image, and differences between the third estimated predicted image and each of the first and second pseudo-ground truths.

16. The complementary learning apparatus of claim 14, wherein the difference loss is calculated as a cumulative sum of a difference between the first difference prediction image and the first difference ground truth, a difference between the second difference prediction image and the first difference pseudo-ground truth, and a difference between the third difference prediction image and the second difference pseudo-ground truth.

17. The complementary learning apparatus of claim 11, wherein the estimating includes the super-resolution model performing super-resolution on each of the first to third low-resolution images through neural network operations to obtain the first to third predicted images having high resolution, and the super-resolution difference model performing neural network operations on each of the first to third image combinations to obtain the first to third difference prediction images.

18. The complementary learning apparatus of claim 11, wherein the super-resolution model and the super-resolution difference model are pre-trained using the low-resolution image and high-resolution image pairs.

19. The complementary learning apparatus of claim 11, wherein the backpropagating includes alternately calculating the super-resolution loss and the difference loss to alternately and repeatedly update the super-resolution model and the super-resolution difference model.
